(19) United States
(12) Patent Application Publication
(10) Pub. No.: US 2005/0156461 A1
(43) Pub. Date: Jul. 21, 2005

(54) Rim and spoke reinforcement structure

(76) Inventors: Douglas Chiang, Dali City (TW); Eric Alan Hjertberg, Dali City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/763,152

(22) Filed: Jan. 21, 2004

(51) Int. Cl. B60B 1/02

(52) U.S. Cl. 301/58

(57) ABSTRACT

A reinforcement structure for a bicycle includes a rim, and a plurality of carbon-fiber locking blocks, spokes and screw members. The carbon-fiber locking blocks are locked on the rim by the screw members and the spokes. Each of the carbon-fiber locking blocks has a first side formed with a planar surface rested on a respective screw member and a second side formed with an arc-shaped surface closely rested on the rim. Thus, the external force applied on each of the screw members is evenly distributed by the arc-shaped surface of the respective carbon-fiber locking block, thereby preventing the screw members from being distorted due to a stress concentration, so as to enhance the safety of riding the bicycle.

### BACKGROUND OF THE INVENTION

1. Field of the Invention

The present invention relates to a rim and spoke reinforcement structure for a bicycle, and more particularly to a reinforcement structure, wherein the rim and the spokes are combined rigidly and stably.

2. Description of the Related Art

A conventional rim and spoke combination structure for a bicycle in accordance with the prior art shown in FIG. 5 comprises a rim 20 formed with a plurality of through holes 22, a plurality of spokes 24 each extended through a respective one of the through holes 22 of the rim 20, and a plurality of screw members 26 each screwed onto a threaded distal end of a respective one of the spokes 24 and rested on the rim 20.

However, the contact area between the rim 20 and each of the screw members 26 is too small, so that when subjected to an external force, the external force applied on each of the screw members 26 cannot be evenly distributed by the rim 20, so that the screw members 26 are easily distorted or deformed due to a stress concentration and are easily loosened from the spokes 24, thereby causing danger to the rider.

### SUMMARY OF THE INVENTION

The primary objective of the present invention is to provide a rim and spoke reinforcement structure for a bicycle.

Another objective of the present invention is to provide a reinforcement structure, wherein the rim and the spokes are combined rigidly and stably.

A further objective of the present invention is to provide a reinforcement structure, wherein when subjected to an external force, the external force applied on each of the screw members is evenly distributed by the arc-shaped surface of a respective one of the carbon-fiber locking blocks, thereby preventing the screw members from being distorted or deformed due to a stress concentration, and thereby preventing the screw members from being loosened from the carbon-fiber locking blocks.

In accordance with the present invention, there is provided a reinforcement structure, comprising a rim, a plurality of carbon-fiber locking blocks, a plurality of spokes, and a plurality of screw members, wherein:
the rim is formed with a plurality of through holes;
each of the carbon-fiber locking blocks is mounted on the rim and is formed with a through hole;
each of the spokes is in turn extended through a respective one of the through holes of the rim and the through hole of a respective one of the carbon-fiber locking blocks; and
each of the screw members is screwed onto a threaded distal end of a respective one of the spokes and rested on a respective one of the carbon-fiber locking blocks.

Further benefits and advantages of the present invention will become apparent after a careful reading of the detailed description with appropriate reference to the accompanying drawings.

### BRIEF DESCRIPTION OF THE DRAWINGS

FIG. 1 is a partially perspective view of a reinforcement structure in accordance with the preferred embodiment of the present invention;

FIG. 2 is an exploded perspective view of the reinforcement structure as shown in FIG. 1;

FIG. 3 is a plan cross-sectional view of the reinforcement structure as shown in FIG. 1;

FIG. 4 is a side plan view of the reinforcement structure for a bicycle in accordance with the preferred embodiment of the present invention; and

FIG. 5 is a plan cross-sectional view of a conventional rim and spoke combination structure for a bicycle in accordance with the prior art.

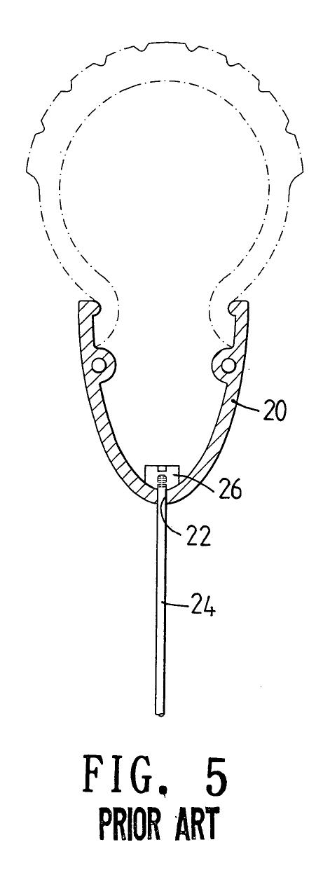

### DETAILED DESCRIPTION OF THE INVENTION

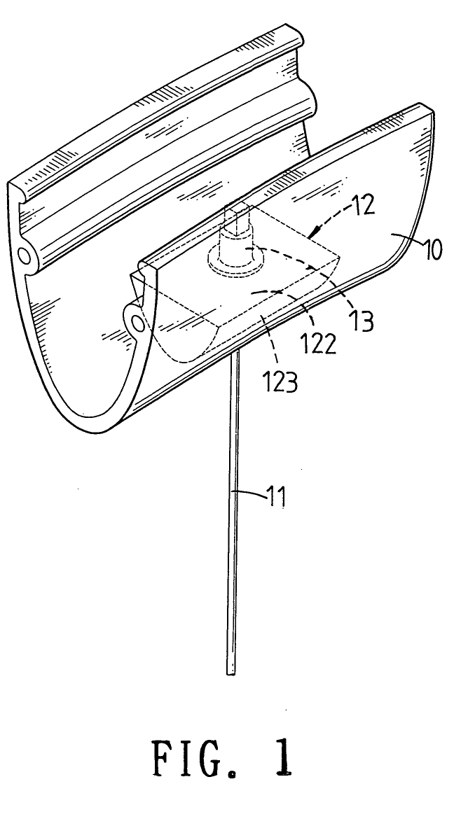

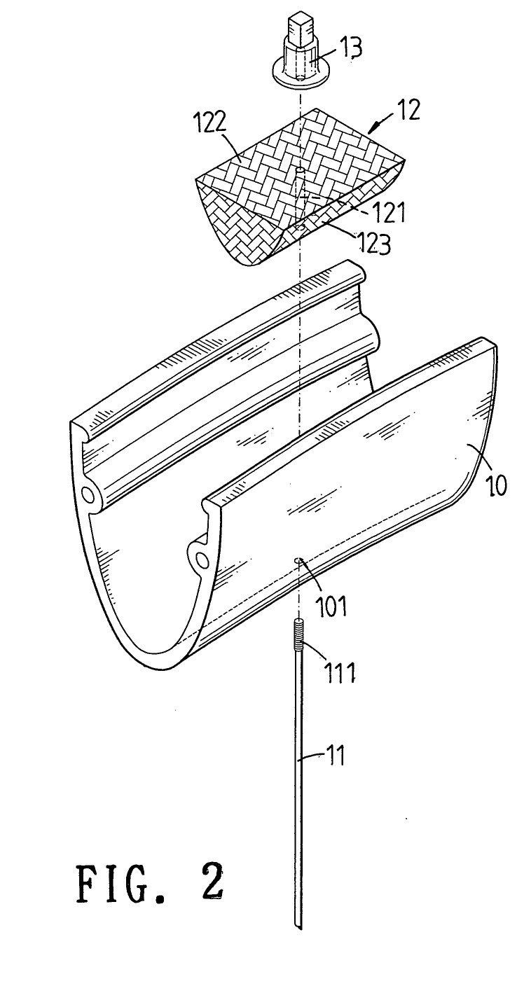

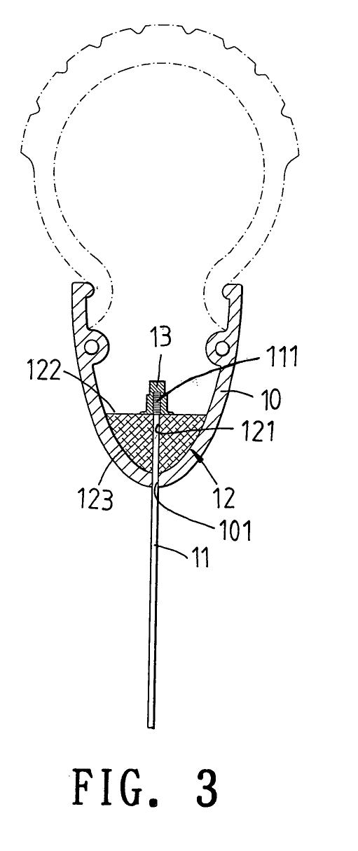

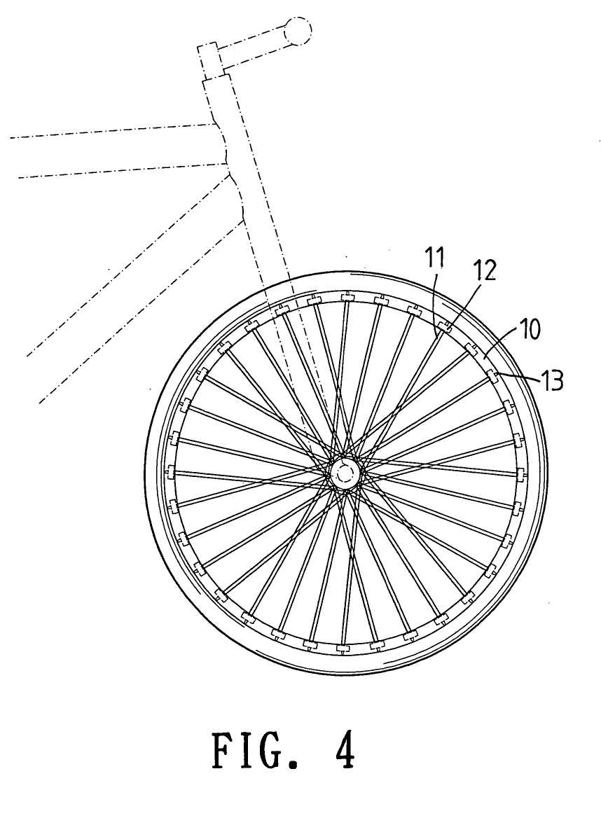

Referring to FIGS. 1-4, a rim and spoke reinforcement structure for a bicycle in accordance with the preferred embodiment of the present invention comprises a rim 10, a plurality of carbon-fiber locking blocks 12, a plurality of spokes 11, and a plurality of screw members 13.

The rim 10 is formed with a plurality of through holes 101.

Each of the carbon-fiber locking blocks 12 is mounted on the rim 10 and is formed with a through hole 121. Each of the carbon-fiber locking blocks 12 has a first side formed with a planar surface 122 and a second side formed with an arc-shaped surface 123 closely rested on the rim 10.

Each of the spokes 11 is in turn extended through a respective one of the through holes 101 of the rim 10 and the through hole 121 of a respective one of the carbon-fiber locking blocks 12 and has a distal end formed with an outer thread 111.

Each of the screw members 13 is screwed onto the outer thread 111 of a respective one of the spokes 11 and rested on the planar surface 122 of a respective one of the carbon-fiber locking blocks 12.

In such a manner, the screw members 13 are combined with the spokes 11, so that the carbon-fiber locking blocks 12 are closely clamped between the rim 10 and the screw members 13.

When in use, the planar surface 122 of each of the carbon-fiber locking blocks 12 is rested on a respective one of the screw members 13, and the arc-shaped surface 123 of each of the carbon-fiber locking blocks 12 is closely rested on the rim 10, so that the carbon-fiber locking blocks 12 are closely clamped between the rim 10 and the screw members 13.

Accordingly, when the rim and spoke reinforcement structure is subjected to an external force, the external force applied on each of the screw members 13 is evenly distributed by the arc-shaped surface 123 of a respective one of the carbon-fiber locking blocks 12, thereby preventing the screw members 13 from being distorted or deformed due to a stress concentration, and thereby preventing the screw members 13 from being loosened from the carbon-fiber locking blocks 12. In addition, the rim 10 and the spokes 11 are combined rigidly and stably without incurring detachment. Further, each of the carbon-fiber locking blocks 12 has a light weight, thereby decreasing the weight of the bicycle without causing a burden to the rider.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A reinforcement structure, comprising a rim, a plurality of carbon-fiber locking blocks, a plurality of spokes, and a plurality of screw members, wherein:
the rim is formed with a plurality of through holes;
each of the carbon-fiber locking blocks is mounted on the rim and is formed with a through hole;
each of the spokes is in turn extended through a respective one of the through holes of the rim and the through hole of a respective one of the carbon-fiber locking blocks; and
each of the screw members is screwed onto a threaded distal end of a respective one of the spokes and rested on a respective one of the carbon-fiber locking blocks.

2. The reinforcement structure in accordance with claim 1, wherein each of the carbon-fiber locking blocks has a first side formed with a planar surface rested on a respective one of the screw members and a second side formed with an arc-shaped surface closely rested on the rim.
